(19) United States
(12) Patent Application Publication
(10) Pub. No.: US 2004/0100076 A1
(43) Pub. Date: May 27, 2004

(54) Multiple stage inflatable curtain

(75) Inventor: Kimberlee Holtz, Rochester Hills, MI (US)

Correspondence Address: CROWELL & MORING LLP, INTELLECTUAL PROPERTY GROUP, P.O. BOX 14300, WASHINGTON, DC, 20044-4300, US

(73) Assignee: Daimler Chrysler Corporation

(21) Appl. No.: 10/302,926

(22) Filed: Nov. 25, 2002

(51) Int. Cl. B60R 21/22

(52) U.S. Cl. 280/730.2

(57) ABSTRACT

An inflatable assembly for protecting occupants of a vehicle, comprising a multi-stage inflating device, and an inflatable device having a plurality of gas channels that are separately inflatable and operatively connected with the inflating device.

### BACKGROUND OF THE INVENTION

The present invention relates to an inflatable curtain for side impact and rollover protection in a vehicle, and more particularly, to a multi-stage inflatable curtain, cushion or airbag that can be “greenhouse”- or door-mounted on the vehicle.

Inflatable airbags and side airbag inflatable curtains (SABICs) have become well accepted for their use in frontal and side impact vehicle crashes. In response to recent Federal Motor Vehicle Safety Standards 208 frontal crash test guidelines, frontal airbags utilize a two-stage (or dual-stage) or other multi-stage airbag inflation approach. That is, the frontal airbag inflates in response to varying occupant positions in addition to vehicle crash impact “signatures”, i.e., the crash pulse at different velocities at impact. Devices for multi-inflation for frontal airbag systems are described, for example, in U.S. Pat. Nos. 6,142,519; 6,274,948; 6,422,601; and 6,474,684.

More recently, side impact protection devices have started to become more commonly employed in passenger vehicles and in sports utility vehicles. For example, side impact airbags and inflatable curtains (or SABICs) have used single-stage airbag inflation for lateral and crabbed barrier testing (FMVSS 214; ECE R95) as well as extended FMVSS 201 pole test modes. Such systems have been described, for example, in U.S. Pat. Nos. 6,224,091; 6,231,071; 6,332,628; 6,378,895; 6,435,543; 6,464,251; and 6,471,240.

Future National Highway Traffic Safety Administration rulemaking is likely to implement rollover occupant protection regulations that will require inflatable devices (SABICs and/or head-thorax side airbags). Such devices will, however, function at an increased complexity compared with the current state of the art, particularly since rollover vehicle crashes require a pressurized airbag for much longer durations than conventional driver/passenger frontal airbags. That is, pressures in rollover airbags will have to maintain pressure for about 5 seconds compared with the required 1 second or less pressure maintenance or “up-time” for frontal airbags. A 5-second up-time demand is considered to require complex airbag fabric manufacture, increased airbag fabric coatings and/or sealants, increased vehicle packaging space because of bulkier fabrics or coatings, reduced recycleability of the fabrics, etc.

### SUMMARY OF THE INVENTION

Objects of the present invention are to achieve increased “up-time” for rollover airbags without the need for complexity in airbag manufacture and without sacrificing compact packaging of the airbag or other current advantages gained only with low up-time airbags.

These objects can be achieved with the present invention by breaking down a rollover vehicle crash into “sectors” that define the occupant-to-inflatable curtain or airbag interaction segments. In other words, the segments represent each phase of the occupant's contact with the inflatable curtain or with an airbag during a typical rollover of a vehicle.

The foregoing objects have been achieved by an inflatable curtain system that is packaged in the headliner or door of a vehicle and in which the inflator has the ability to fire and deliver multiple shots of gas for up to, for example, 5 seconds of up-time or whatever period of time may be necessary for multi-staging.

An advantage of the present invention is that up-time can be increased without the need for required cushion fabric coatings or sealants that increase the packaging size and without the need of any special cushion materials. Therefore, the present invention provides a curtain, cushion or airbag that can be sewn or can be fabricated with woven or non-woven materials and yet withstand multiple pressurizations and depressurizations during different rollover segments.

A yet further advantage of the present invention is that the dimensions of the inflatable device are not restricted in terms of length, size, shape and the like.

### BRIEF DESCRIPTION OF THE DRAWINGS

These and other objects, features and advantages of the present invention will become more readily apparent from the following detailed description of currently preferred configurations thereof when taken in conjunction with the accompanying drawings wherein:

FIG. 1 is a schematic cross-sectional view of the interior of a vehicle along its longitudinal direction with the inflatable curtain deployed in accordance with the present invention;

FIG. 2 is a cross-sectional view taken along line 2-2 of FIG. 1;

FIG. 3 is a view similar to FIG. 1 but showing the curtain in its packaged state in the vehicle headliner prior to deployment; and

FIGS. 4A and 4B are cross-sectional views taken along line B-B in FIG. 3 showing, respectively, coated and uncoated cushion fabric embodiments in accordance with the present invention.

### DETAILED DESCRIPTION OF THE DRAWINGS

For clarity of understanding of the present invention, I will dispense with a description of unnecessary details of construction and operation of a side-impact inflatable curtain, which includes bags, cushions and window bags, as these details are within the ordinary skill of those in this art. Furthermore, although the illustrated embodiment shows an inflatable curtain that is “greenhouse” or roof-mounted, i.e., at the portion of the vehicle from the door window bottom to the top of the roof, the present invention is equally applicable, with modifications again within the ordinary skill of those in the art, to door-mounted and pillar-mounted inflatable cushions.

It should also be understood that the particular chambers in the inflatable curtain shown in the drawings can be configured as single or multiple chambers and can be designed in a way that is vehicle-specific. They can also be arranged to fill simultaneously or in a predetermined order or completely randomly.

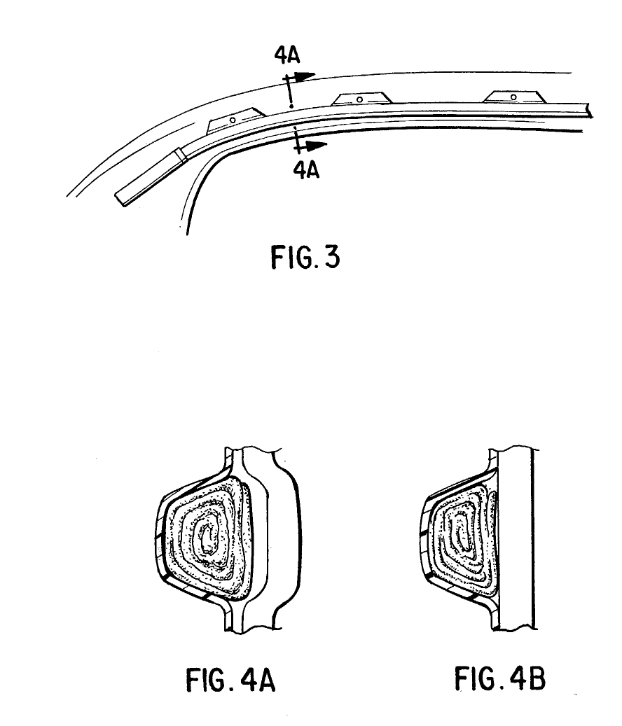

Referring now to the drawings and, in particular, to FIG. 3, the inflatable curtain assembly of the present invention designated generally by numeral 10 is shown in its stowed, undeployed position in the “greenhouse” position of a vehicle roof 1 between the outer sheet metal roof skin 12 and the interior cloth or the like headliner 13. A multi-shot inflator device 14 configured to provide multiple bursts of gas of generally known construction is connected with the curtain 10 and is conveniently located in the region of the vehicle's C-pillar in this embodiment. Of course, the constructional particulars of how the multi-stage inflator device is constructed and where the inflator device is located is incidental to the scope of the present invention and well within the ordinary skill of workers in this art. The assembly 10 is mountable at locations 15, 16, 17.

Depending upon the construction of the airbag cushion or curtain 18, 18′ as shown in FIGS. 4A and 4B, the packaging of the assembly 10 will be bulkier or shallower. That is, the present invention can be used with conventional airbag cushions or curtains 18 as shown in FIG. 4A wherein the cushion is coated to retain the charge of inflation fluid. This results in bulkier packaging of the cushion 18 accommodated in the housing 19 as seen by the bulge created in the headliner 13. An advantage of the present invention is, however, that it can be used with curtains and cushions 18′ that are not coated as seen in FIG. 4B. Consequently, the curtain 18′ is held between the housing 19′ and the headliner 13′ does not create the bulge in the headliner but instead results in a shallower, more compact packaging.

Referring now to FIG. 1 the airbag cushion assembly 10 of FIG. 3, in this embodiment shown as a side-impact/rollover protection system, has been fully deployed from the A-pillar 20 to the C-pillar 21. In vehicles such as SUVs, SABICs can extend to the D-pillar and this is contemplated by the present invention. The assembly 10 can consist of eight gas channels 22, 23, 24, 25, 26, 27, 28, 29 of different sizes and shapes. Again, the size and number of the channels as well as their location can be vehicle-specific and/or end-use specific. Moreover, they can be filled simultaneously by the inflator device 14, sequentially or at random. For example, they can be inflatable by appropriate design of the inflator device or by conventional control circuitry to fill the gas channels in response to a sensed rollover in accordance with the contemplated segments of occupant-to-inflatable cushion contact. As used throughout this disclosure, “curtain”, “cushion” and “airbag” are used interchangeably.

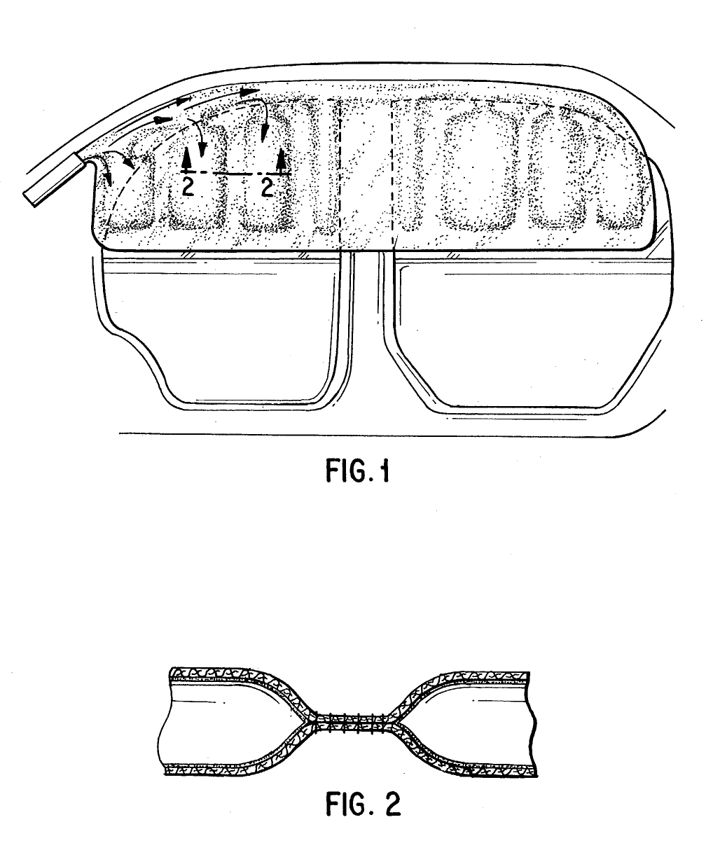

As seen in FIG. 2, a base fabric 25 can constitute the inflatable curtain assembly 10 as shown in FIG. 4A. Alternatively, a layer of silicone coating 26 or the like can be applied (see also FIG. 4B) to seal the inflating gases in the gas channels (channels 23, 24 being illustrated) for the necessary up-time. The area 27 between the channels can either be a fabric weave or sewn together with stitching.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

I claim:

1. An inflatable assembly for protecting occupants of a vehicle, comprising a multi-stage inflating device, and an inflatable device having a plurality of gas channels that are separately inflatable and operatively connected with the inflating device.

2. An inflatable assembly according to claim 1, wherein the inflating device is configured to fire and supply an inflating substance for up to about 5 seconds.

3. An inflatable assembly according to claim 1, wherein the inflating device is configured to fire and supply an inflating substance for a predetermined time period.

4. An inflatable assembly according to claim 1, wherein the gas channels are arranged to be inflatable in a predefined order in response to rollover of the vehicle.

5. An inflatable assembly according to claim 1, wherein the inflatable device is located at one of an A-pillar, a B-pillar and between a C-pillar and the A-pillar of the vehicle.

6. An inflatable assembly according to claim 1, wherein the inflatable device is a curtain arranged in the vicinity of a roof of the vehicle.

7. An inflatable assembly according to claim 1, wherein the inflatable device is made of a coated fabric or uncoated fabric.

8. An inflatable assembly according to claim 1, wherein the gas channels can be configured to be of different size and/or different shape.

9. An inflatable assembly according to claim 1, wherein the gas channels are arranged to be inflated simultaneously by the inflator device.

10. An inflatable assembly according to claim 1, wherein the gas channels are arranged to be inflated randomly by the inflator device.

11. An inflatable assembly according to claim 1, wherein the inflatable device is arranged for protecting the vehicle occupants from side impacts.

12. An inflatable assembly according to claim 1, wherein the inflatable device is arranged for protecting the vehicle occupants from rollovers.

13. An inflatable device according to claim 12, wherein the inflatable device is arranged for protecting the vehicle occupants from side impacts.

14. An inflatable assembly according to claim 1, wherein the inflatable device is configured to form a compact package within the vehicle.
